(19) United States
(12) Patent Application Publication
(10) Pub. No.: US 2026/0340999 A1
(43) Pub. Date: Oct. 29, 2026

(54) TRAINING DEVICE, TRAINING METHOD, AND RECORDING MEDIUM

(71) Applicant: NEC Corporation, Tokyo (JP)

(72) Inventors: Naoya SOGI, Tokyo (JP); Makoto Terao, Tokyo (JP); Takashi Shibata, Tokyo (JP); Taku Fujitomi, Tokyo (JP); Ren Ohukubo, Tokyo (JP)

(73) Assignee: NEC Corporation, Tokyo (JP)

(21) Appl. No.: 19/533,480

(22) Filed: Feb. 9, 2026

(30) Foreign Application Priority Data
Mar. 3, 2025 (JP) 2025-032770

(51) Int. Cl. G06V 10/774; G06F 40/40; G06V 10/82

(52) U.S. Cl. CPC G06V 10/774; G06F 40/40; G06V 10/82

(57) ABSTRACT

In a training device, a label generation means generates a label representing both a caption generated from an image by a learning model and text representing the image. A training means updates the learning model using data including the label and the image.

### INCORPORATION BY REFERENCE

This application is based upon and claims the benefit of priority from Japanese patent application No. 2025-032770, filed on Mar. 3, 2025, the disclosure of which is incorporated herein in its entirety by reference.

### TECHNICAL FIELD

The present disclosure relates to an additional training technique.

### BACKGROUND ART

When additional training or continuous training of a vision and language model is performed, a phenomenon called “forgetting” in which learned knowledge is forgotten may occur. In this regard, Patent Document 1 proposes a machine learning system capable of performing additional training by dividing pieces of training data and training means for old knowledge and for new knowledge and acquiring the new knowledge while suppressing forgetting of the old knowledge.

Patent Document 1: JP 2023-181643 A

### SUMMARY

However, an image has a variety of meanings, and the vision and language model before additional training knows a variety of information regarding the image. It is not always possible to prevent the forgetting of learned knowledge with a method of Patent Document 1.

One object of the present disclosure is to provide a training device capable of improving retrieval accuracy for a learning target while preventing forgetting of learned knowledge.

According to an example aspect of the present invention, there is provided a training device, including:
at least one memory configured to store instructions; and
at least one processor configured to execute the instructions to:
   generate a label representing both a caption generated from an image by a learning model and text representing the image; and
   update the learning model using data including the label and the image.

According to another example aspect of the present invention, there is provided a training method including:
generating a label representing both a caption generated from an image by a learning model and text representing the image; and
updating the learning model using data including the label and the image.

According to a further example aspect of the present invention, there is provided a recording medium recording a program for causing a computer to execute processing including:
generating a label representing both a caption generated from an image by a learning model and text representing the image; and
updating the learning model using data including the label and the image.

According to the present disclosure, it is possible to improve the retrieval accuracy for the learning target while preventing the forgetting of learned knowledge.

### BRIEF DESCRIPTION OF THE DRAWINGS

FIGS. 1A and 1B illustrate an additional training device according to the present disclosure;

FIG. 2 is a block diagram illustrating a hardware configuration of the additional training device according to the present disclosure;

FIG. 3 is a block diagram illustrating a functional configuration of the additional training device according to the present disclosure;

FIG. 4 is a flowchart of processing by the additional training device according to the present disclosure;

FIG. 5 is a block diagram illustrating a functional configuration of an additional training device according to a modified example;

FIG. 6 is a block diagram illustrating a functional configuration of another additional training device according to the present disclosure;

FIG. 7 is a flowchart of processing by the another additional training device according to the present disclosure;

FIG. 8 is a block diagram illustrating a functional configuration of still another additional training device according to the present disclosure;

FIG. 9 is a flowchart of processing by the still another additional training device according to the present disclosure;

FIG. 10 is a block diagram illustrating a functional configuration of even still another additional training device according to the present disclosure; and

FIG. 11 is a flowchart of processing by the even still another additional training device according to the present disclosure.

### EXAMPLE EMBODIMENT

Hereinafter, preferred example embodiments of the present disclosure will be described with reference to the drawings. Note that any character with a symbol “-” above the character is represented as “A⁻” (“A” is any character) for convenience in the present specification.

### First Example Embodiment

### Outline Description

In the present example embodiment, additional training of a Vision and Language Model (VLM) is described as an example. VLMs are machine learning models capable of integrally processing visual information (images and videos) and text information (language data), and are used for tasks such as image retrieval, image caption generation, and visual question answering.

When additional training is performed on a VLM, a phenomenon called “forgetting” in which learned knowledge is forgotten may occur. For example, in a case where additional training is performed on a VLM capable of image retrieval related to a person using a data set aiming at an image of a car, accuracy of the image retrieval related to a person is deteriorated although accuracy of image retrieval related to a car is improved. Therefore, the present example embodiment provides a training device capable of improving retrieval accuracy for a learning target while preventing forgetting of learned knowledge.

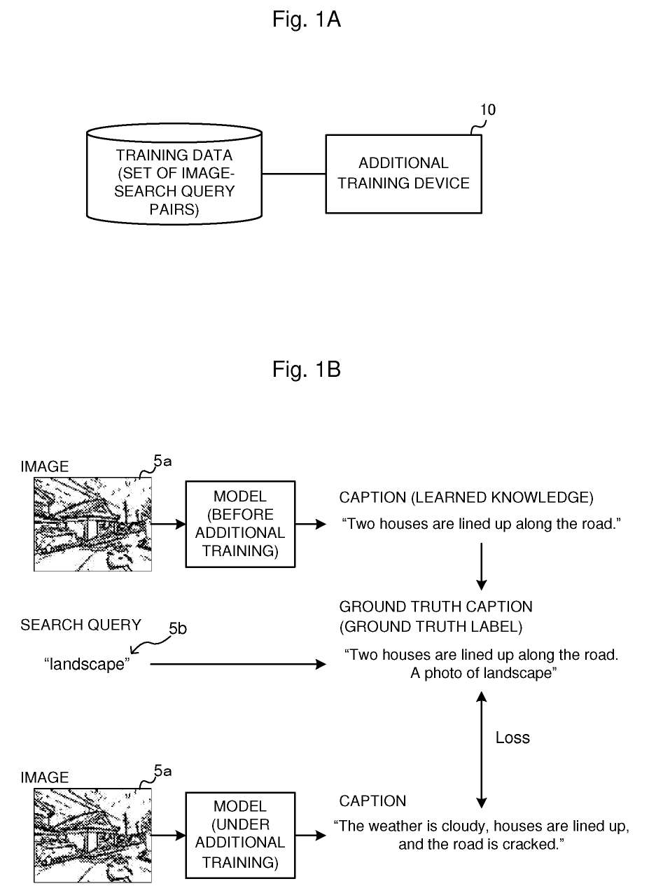

FIGS. 1A and 1B illustrate an additional training device according to the present example embodiment. FIG. 1A illustrates an overall configuration of the additional training device. An additional training device 10 performs additional training of a VLM using training data as an input. The training data includes pairs of images and search queries desired to be newly retrievable. The search query is a word, a phrase, a sentence, or the like used for retrieval. The additional training device 10 is an example of a training device.

FIG. 1B illustrates an outline of additional training by the additional training device 10. Note that a pair of an image 5a and a search query 5b in FIG. 1B is training data and indicates that it is desired to make the image 5a retrievable also with the search query 5b. A VLM, such as Bootstrapping Language-Image Pre-training 2 (BLIP-2) or Large Language and Vision Assistant (LLaVA), is used as a model.

First, the additional training device 10 inputs the image 5a to the model before additional training and acquires a descriptive text (hereinafter, also referred to as a “caption”) of the image. Then, the additional training device 10 integrates the caption generated by the model before additional training and the search query 5b to generate a ground truth caption (that is, a ground truth label or a label). Next, the additional training device 10 inputs the image 5a to the model being additionally trained and acquires a caption. The additional training device 10 updates a parameter of the model being additionally trained in such a way as to reduce a loss between the ground truth caption and the caption generated by the model being additionally trained.

As described above, the additional training device 10 integrates the caption (that is, learned knowledge) output from the model before additional training and the search query (that is, new knowledge) included in the training data to obtain a learning target (ground truth label or label), and additionally trains the model with the learning target. As a result, the additional training device 10 can perform additional training that improves retrieval accuracy for a new learning target without forgetting learned knowledge (that is, without deteriorating trained retrieval performance).

Note that the search query 5b is an example of text representing an image.

### Hardware Configuration

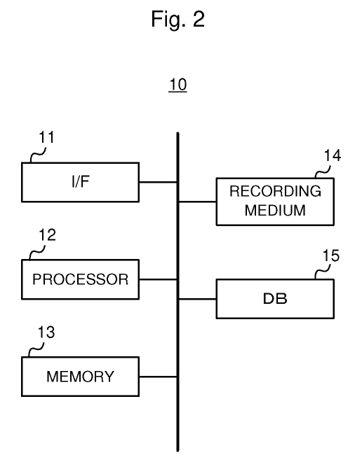

FIG. 2 is a block diagram illustrating a hardware configuration of the additional training device 10 according to the first example embodiment. As illustrated, the additional training device 10 includes an interface (I/F) 11, a processor 12, a memory 13, a recording medium 14, and a database (DB) 15.

The I/F 11 exchanges data with an external device. Specifically, the I/F 11 acquires training data used by the additional training device 10 from the external device.

The processor 12 is a computer such as a central processing unit (CPU), and controls the entire additional training device 10 by executing a program prepared in advance. The processor 12 may be a graphics processing unit (GPU), a digital signal processor (DSP), a micro processing unit (MPU), a floating point unit (FPU), a physics processing unit (PPU), a tensor processing unit (TPU), a quantum processor, a microcontroller, or a combination thereof. The processor 12 executes additional training processing to be described later.

The memory 13 includes a read only memory (ROM), a random access memory (RAM), and the like. The memory 13 is also used as a work memory during execution of various types of processing by the processor 12.

The recording medium 14 is a non-volatile non-transitory recording medium such as a disk-shaped recording medium or a semiconductor memory and is attachable to and detachable from the additional training device 10. The recording medium 14 records various programs to be executed by the processor 12. When the additional training device 10 executes various types of processing, the programs recorded in the recording medium 14 are loaded into the memory 13 and executed by the processor 12. The DB 15 stores a caption to be described later, similarity between an image and a search query, and the like.

In addition to the above, the additional training device 10 may include a display device such as a liquid crystal display and an input device such as a keyboard and a mouse. The display device and the input device are used by an administrator of the additional training device 10 to perform necessary management, for example.

### Functional Configuration

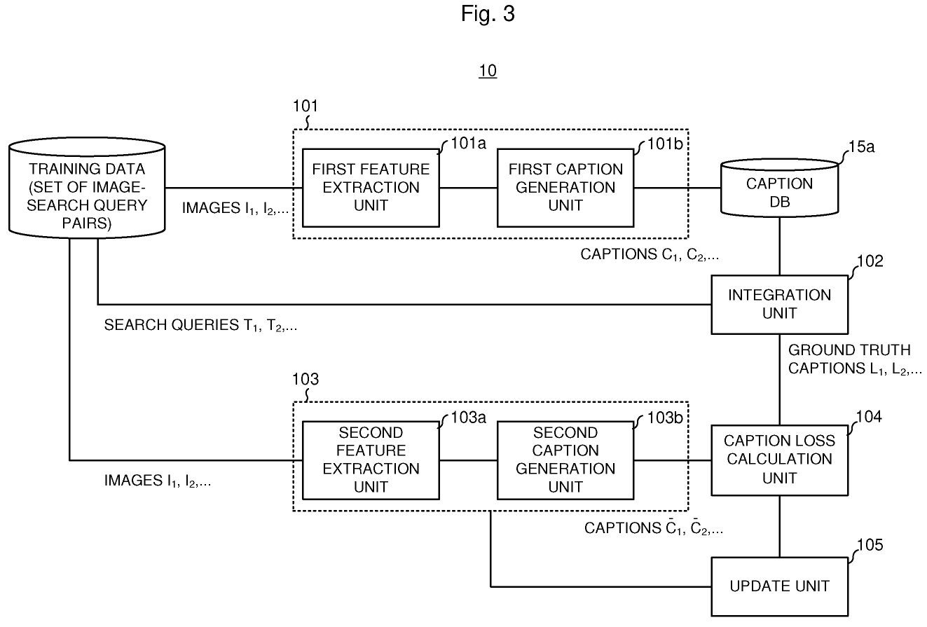

FIG. 3 is a block diagram illustrating a functional configuration of the additional training device 10 according to the first example embodiment. The additional training device 10 functionally includes a to-be-trained model 101, an integration unit 102, an in-training model 103, a caption loss calculation unit 104, an update unit 105, and a caption DB 15a.

The caption DB 15a is achieved by the DB 15 illustrated in FIG. 2. Furthermore, the to-be-trained model 101, the integration unit 102, the in-training model 103, the caption loss calculation unit 104, and the update unit 105 are configured by the processor 12 illustrated in FIG. 2.

The to-be-trained model 101 and the in-training model 103 are models that can generate captions of images using the images and sentences as inputs. The in-training model 103 is a model in the middle of being additionally trained based on the to-be-trained model 101. For example, a VLM such as BLIP-2 or LLaVA is used as the to-be-trained model 101 and the in-training model 103.

Training data is input into the to-be-trained model 101. The training data is a set of pairs respectively including images (I₁, I₂, and so on) and search queries (T₁, T₂, and so on). Note that I₁ represents the first image, and I₂ represents the second image. Furthermore, T₁ represents a search query for the first image, and T₂ represents a search query for the second image. A pair of the image I₁ and the search query T₁ indicates that it is desired to make the image I₁ retrievable by the search query T₁, and a pair of the image I₂and the search query T₂ indicates that it is desired to make the image I₂ retrievable by the search query T₂.

The to-be-trained model 101 generates descriptive texts (hereinafter, also referred to as “captions”) (C₁, C₂, and so on) of the images from the images (I₁, I₂, and so on) of the training data, and outputs the generated descriptive texts to the caption DB 15a. Note that C₁ represents a caption generated from the first image, and C₂ represents a caption generated from the second image.

Specifically, the to-be-trained model 101 includes a first feature extraction unit 101a and a first caption generation unit 101b. The first feature extraction unit 101a extracts a feature of an input image and outputs the feature to the first caption generation unit 101b. The first feature extraction unit 101a can extract the feature of the image using, for example, a convolutional neural network (CNN)-based model, such as Visual Geometry Group (VGG) or a residual network (ResNet), or a vision transformer (ViT)-based model.

The first caption generation unit 101b generates a caption from the input feature of the image and outputs the generated caption to the caption DB 15a. The first caption generation unit 101b can generate text (caption) related to the feature of the image using, for example, a transformer decoder or recurrent neural network (RNN)-based model or the like.

In a case where there is randomness in caption generation and different captions can be generated from a feature of the same image, the first caption generation unit 101b may execute caption generation a plurality of times for the single image to generate a plurality of captions. In this case, the integration unit 102 described later may combine all of the plurality of captions for the single image and use the combined captions for processing or may combine captions randomly selected from among the plurality of captions and use the combined captions for processing. Captions are combined by punctuating a plurality of captions using a punctuation mark or the like. Furthermore, the integration unit 102 may randomly select one caption from among the plurality of captions for the single image and use the selected caption for processing.

The caption DB 15a stores the image of the training data and the caption generated by the to-be-trained model 101 in association with each other.

The integration unit 102 integrates the caption (learned knowledge) generated by the to-be-trained model 101 and a query (new knowledge) desired to be newly retrievable to generate a ground truth caption. Specifically, the search queries (T₁, T₂, and so on) of the training data are input to the integration unit 102. Furthermore, the captions (C₁, C₂, and so on) are input from the caption DB 15a to the integration unit 102. The integration unit 102 integrates the captions (C₁, C₂, and so on) and the search queries (T₁, T₂, and so on) of the training data to generate ground truth captions (L₁, L₂, and so on) to be used for training. The integration unit 102 outputs the ground truth captions to the caption loss calculation unit 104. Note that L₁ represents a ground truth caption for the first image, and L₂ represents a ground truth caption for the second image.

For example, the integration unit 102 can integrate the caption and the search query using a delimiter. The integration unit 102 can use a punctuation mark, a predefined word or phrase, or the like as the delimiter. Hereinafter, examples of integrating captions and search queries (that is, examples of generating ground truth captions) will be described.

(Example 1) Case where punctuation mark is used as delimiter
The integration unit 102 generates the ground truth caption L₁ from the search query T₁ and the caption C₁.
   Search query T₁: person
   Caption C₁: car
   Ground truth caption L₁: person. car.

(Example 2) Case where predefined phrase is used as delimiter
The integration unit 102 generates the ground truth caption L₂ from the search query T₂ and the caption C₂ using a predefined phrase “A photo of”.
   Search query T₂: landscape
   Caption C₂: Two houses are lined up along the road
   Ground truth caption L₂: Two houses are lined up along the road. A photo of landscape

Note that the integration unit 102 may correct a text obtained by integrating a caption and a search query into a natural text. For example, the integration unit 102 inputs the text obtained by integrating the search query and the caption into a natural language processing model and acquires a calibrated text from the natural language processing model. The integration unit 102 sets the calibrated text as a ground truth caption. The natural language processing model is a model that outputs, as text, an answer to input text. Examples of the natural language processing model include large language models (LLMs).

The training data is input into the in-training model 103. The in-training model 103 generates captions (C₁, C₂, and so on) from the images (I₁, I₂, and so on) of the training data and outputs the generated captions to the caption loss calculation unit 104. Note that C₁ represents a caption generated from the first image, and C₂ represents a caption generated from the second image.

Specifically, the in-training model 103 includes a second feature extraction unit 103a and a second caption generation unit 103b. The second feature extraction unit 103a extracts a feature of an input image and outputs the feature to the second caption generation unit 103b. The second feature extraction unit 103a can extract the feature of the image using, for example, a CNN-based model such as VGG or ResNet or a Vision Transformer (ViT)-based model. The second caption generation unit 103b generates a caption from the feature of the input image and outputs the generated caption to the caption loss calculation unit 104. The second caption generation unit 103b can generate text (caption) related to the feature of the image using, for example, a transformer decoder, an RNN-based model, or the like.

The caption loss calculation unit 104 uses a loss function such as cross-entropy to calculate an error (hereinafter, also referred to as a “caption loss”) between the ground truth caption and the caption generated by the in-training model 103. The caption loss calculation unit 104 outputs the caption loss to the update unit 105.

The update unit 105 updates a parameter of the in-training model 103 based on the caption loss. The update unit 105 calculates a gradient of the loss function with respect to the parameter (weight or bias) of the model and updates the parameter of the model in such a way as to minimize the loss function using an optimization algorithm such as stochastic gradient descent (SGD) or adaptive moment estimation (Adam).

Note that parameters updated by the update unit 105 may be all parameters (the second feature extraction unit 103a and the second caption generation unit 103b) or a part of the parameters.

Furthermore, the update unit 105 may prepare and update an additional parameter instead of updating an original parameter. Furthermore, the update unit 105 may update both the original parameter and the additional parameter. The update unit 105 can prepare and update the additional parameter using a method such as prompt tuning, low-rank adaptation (LoRA), or reparameterized fine-tuning (ReFT).

The update unit 105 ends the processing when the loss between the output of the in-training model 103 and the ground truth caption converges to a predetermined range, and regards the in-training model 103 at this time as an additionally trained model.

In the above configuration, the to-be-trained model 101 is an example of a learning model before being updated, the integration unit 102 is an example of a label generation means, the in-training model 103 is an example of a learning model being updated, and the caption loss calculation unit 104 and the update unit 105 are examples of a training means.

### Additional Training Processing

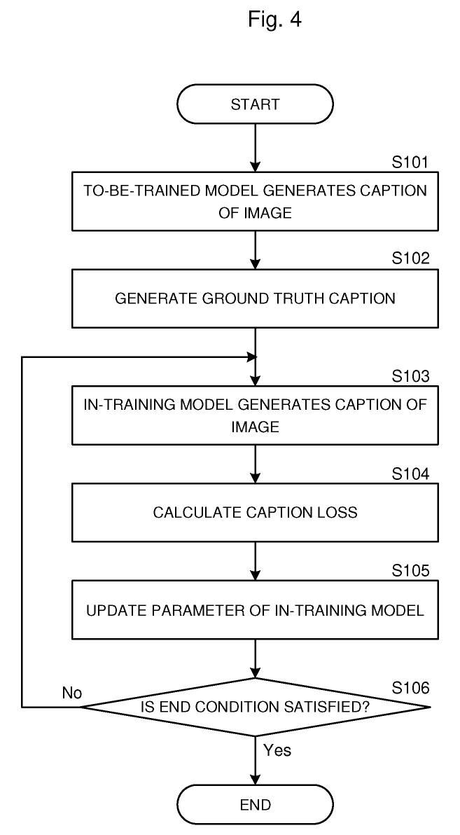

Next, processing of performing the additional training as described above will be described. FIG. 4 is a flowchart of additional training processing by the additional training device 10. This processing is achieved by the processor 12 illustrated in FIG. 2 executing a program prepared in advance and operating as each element illustrated in FIG. 3.

First, an image of training data is input to the to-be-trained model 101. The to-be-trained model 101 generates a caption of the image from the image of the training data (step S101). The to-be-trained model 101 outputs the generated caption to the caption DB 15a.

Next, a search query of the training data is input to the integration unit 102. Furthermore, the caption generated by the to-be-trained model 101 is input from the caption DB 15a to the integration unit 102. The integration unit 102 integrates the search query of the training data and the caption generated by the to-be-trained model 101 to generate a ground truth caption (step S102).

Next, the image of the training data is input to the in-training model 103. The in-training model 103 generates a caption of the image from the image of the training data (step S103). The in-training model 103 outputs the generated caption to the caption loss calculation unit 104.

Next, the caption loss calculation unit 104 calculates a caption loss based on the ground truth caption and the caption generated by the in-training model 103 (step S104). Specifically, the caption loss calculation unit 104 uses a loss function such as cross-entropy to calculate an error between the ground truth caption and the caption generated by the in-training model 103. The caption loss calculation unit 104 outputs the caption loss to the update unit 105.

Next, the update unit 105 updates a parameter of the in-training model 103 based on the caption loss (step S105). The processing in steps S103 to S105 is repeatedly executed until a predetermined end condition is satisfied, and the processing ends in a case where the predetermined end condition is satisfied (step S106: Yes).

The additional training device 10 of the first example embodiment can perform additional training that improves the retrieval accuracy for a learning target while preventing the forgetting of learned knowledge.

### Modified Example

Next, a modified example of the first example embodiment will be described.

Among VLMs, there is a model that can generate a caption using not only an image but also an image and a text. For example, in a case where an image and a text (for example, “there are”) are input, the VLM as described above can predict a continuation of the text (for example, “houses. A photo of dogs”).

An additional training device 10x of the modified example performs additional training on the VLM as described above using an image and a text as inputs in such a way that a continuation of the text can be appropriately predicted.

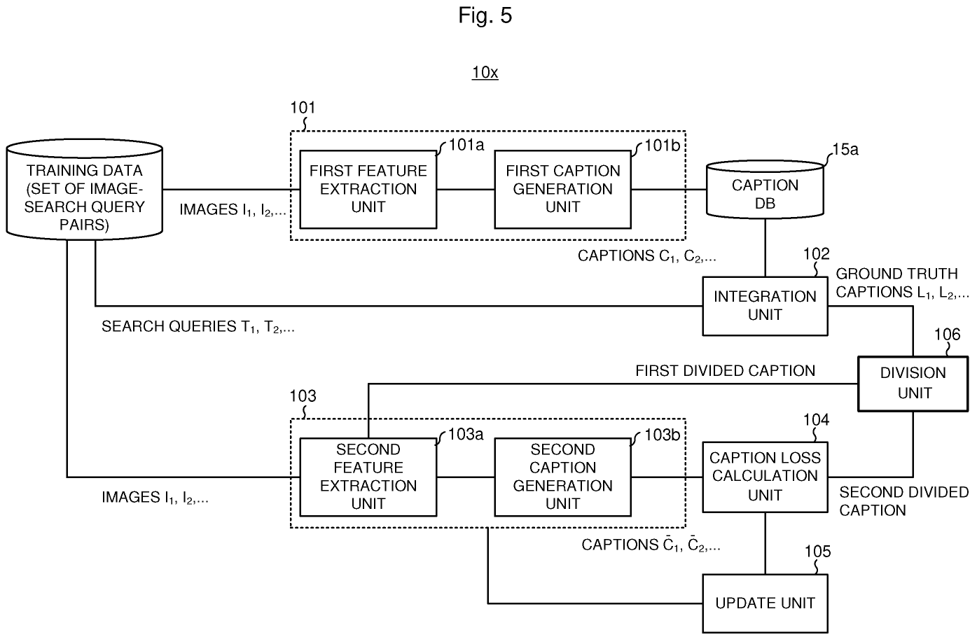

FIG. 5 is a block diagram illustrating a functional configuration of the additional training device 10x. The additional training device 10x functionally includes the to-be-trained model 101, the integration unit 102, the in-training model 103, the caption loss calculation unit 104, the update unit 105, a division unit 106, and the caption DB 15a.

Since the to-be-trained model 101, the integration unit 102, and the update unit 105 operate similarly to those of the additional training device 10 of the first example embodiment, the description thereof will be omitted.

The division unit 106 divides a ground truth caption into a portion to be input to the in-training model 103 and a portion to be treated as a ground truth. Specifically, the ground truth caption is input from the integration unit 102 to the division unit 106. The division unit 106 divides the ground truth caption into two portions. The division unit 106 may divide the ground truth caption into two portions at randomly determined positions or may divide the ground truth caption into two portions based on a delimiter such as a punctuation mark. The division unit 106 outputs one divided portion of the ground truth caption to the in-training model 103 and outputs the other portion to the caption loss calculation unit 104. For example, the division unit 106 divides a ground truth caption “there are houses. A photo of landscape” into “there are” and “houses. A photo of landscape”, outputs “there are” to the in-training model 103, and outputs “houses. A photo of landscape” to the caption loss calculation unit 104.

The one portion (hereinafter, also referred to as a “first divided caption”) of the ground truth captions divided by the division unit 106 is input to the second feature extraction unit 103a of the in-training model 103. The second feature extraction unit 103a extracts a feature of the first divided caption and outputs the feature to the second caption generation unit 103b. The second feature extraction unit 103a can extract the feature of the first divided caption using a transformer-based model such as bidirectional encoder representations from transformers (BERT) or a method such as text embeddings. The second caption generation unit 103b generates a caption using a feature of an image and the feature of the first divided caption as inputs. The second caption generation unit 103b outputs the generated caption to the caption loss calculation unit 104.

The other portion (hereinafter, also referred to as a “second divided caption”) of the ground truth caption divided by the division unit 106 is input to the caption loss calculation unit 104. Note that the second divided caption is the portion treated as the ground truth. Furthermore, the caption generated by the in-training model 103 from the in-training model 103 is input to the caption loss calculation unit 104. The caption loss calculation unit 104 calculates a caption loss between the second divided caption and the caption generated by the in-training model 103. The caption loss calculation unit 104 outputs the caption loss to the update unit 105. The update unit 105 updates a parameter of the in-training model 103 based on the caption loss.

As described above, the additional training device 10x of the modified example can perform the additional training of the VLM in such a way that a continuation of a text is appropriately predicted using an image and the text as inputs.

In the above configuration, the division unit 106 is an example of a division means. The first divided caption is an example of first information, and the second divided caption is an example of second information.

### Second Example Embodiment

Next, a second example embodiment will be described. In the second example embodiment, a parameter of a model is updated by combining a plurality of losses. Since an overall configuration and a hardware configuration of an additional training device 20 according to the second example embodiment are similar to those of the additional training device 10 according to the first example embodiment, the description thereof will be omitted. The additional training device 20 is an example of a training device.

### Functional Configuration

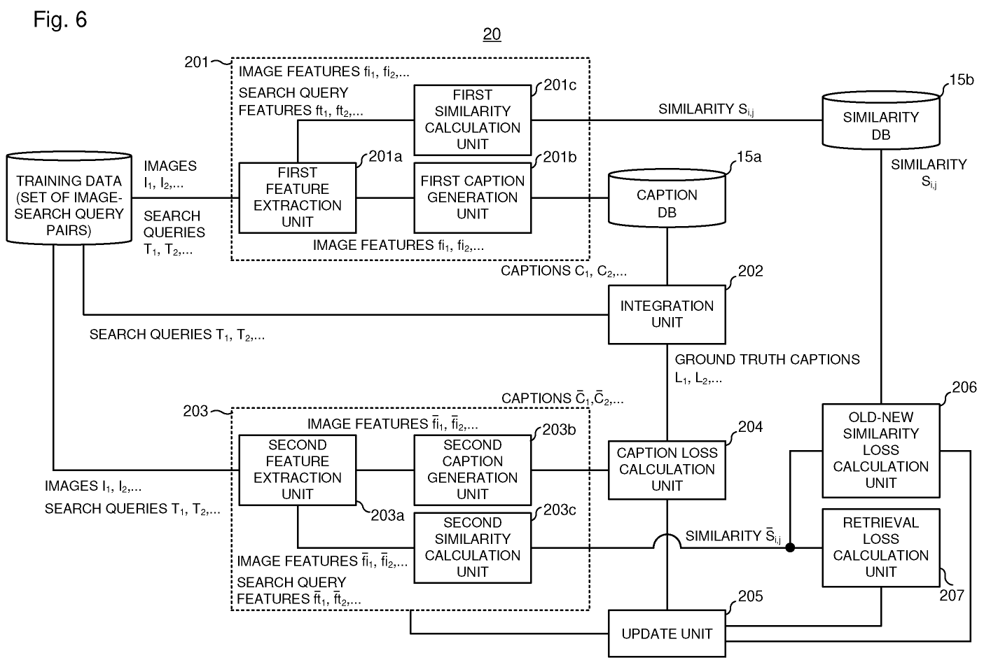

FIG. 6 is a block diagram illustrating a functional configuration of the additional training device 20. The additional training device 20 functionally includes a to-be-trained model 201, an integration unit 202, an in-training model 203, a caption loss calculation unit 204, an update unit 205, an old-new similarity loss calculation unit 206, a retrieval loss calculation unit 207, the caption DB 15a, and a similarity DB 15b.

The caption DB 15a and the similarity DB 15b are achieved by the DB 15 illustrated in FIG. 2. The to-be-trained model 201, the integration unit 202, the in-training model 203, the caption loss calculation unit 204, the update unit 205, the old-new similarity loss calculation unit 206, and the retrieval loss calculation unit 207 are configured by the processor 12 illustrated in FIG. 2.

Since the integration unit 202 and the caption loss calculation unit 204 are similar to the integration unit 102 and the caption loss calculation unit 104 of the additional training device 10, the description thereof will be omitted.

Training data is input into the to-be-trained model 201. The training data is a set of pairs respectively including images (I₁, I₂, and so on) and search queries (T₁, T₂, and so on) as in the first example embodiment. The to-be-trained model 201 generates captions from the images of the training data and outputs the generated captions to the caption DB 15a. Furthermore, the to-be-trained model 201 calculates the similarity between each of the images and each of the search queries and outputs the similarity to the similarity DB 15b.

Specifically, the to-be-trained model 201 includes a first feature extraction unit 201a, a first caption generation unit 201b, and a first similarity calculation unit 201c. Since the first caption generation unit 201b is similar to the first caption generation unit 101b of the additional training device 10, and thus the description thereof will be omitted.

The first feature extraction unit 201a extracts features of the images and features of the search queries from the training data. Then, the first feature extraction unit 201a outputs features (fi₁, fi₂, and so on) of the images to the first caption generation unit 201b, and outputs the features (fi₁, fi₂, and so on) of the images and features (ft₁, ft₂, and so on) of the search queries to the first similarity calculation unit 201c. Note that fi₁ represents a feature extracted from the first image, and fi₂ represents a feature extracted from the second image. Furthermore, ft₁ represents a feature extracted from a search query associated to the first image, and ft₂ represents a feature extracted from a search query associated to the second image. The first feature extraction unit 201a can extract the features of the images using, for example, a CNN-based model such as VGG or ResNet or a Vision Transformer (ViT) -based model. Furthermore, the first feature extraction unit 201a can extract the features of the search queries using a transformer-based model such as BERT.

The first similarity calculation unit 201c maps the feature of each of the images and the feature of each of the search queries in the same feature space and calculates the similarity of each pair of the image and the search query using the cosine similarity and the Euclidean distance. Then, the first similarity calculation unit 201c generates a similarity matrix (S_{i,j}) showing values of the similarity in the form of a matrix and outputs the similarity matrix to the similarity DB 15b. Note that S_{i,j} represents the similarity between the i-th image and the j-th search query.

The similarity DB 15b stores the similarity of each of all pairs of the images and the search queries included in the training data.

The training data is input into the in-training model 203. The in-training model 203 generates captions from the images of the training data and outputs the generated captions to the caption loss calculation unit 204. The in-training model 203 calculates the similarity between each of the images and each of the search queries and outputs the similarity to the old-new similarity loss calculation unit 206 and the retrieval loss calculation unit 207.

Specifically, the in-training model 203 includes a second feature extraction unit 203a, a second caption generation unit 203b, and a second similarity calculation unit 203c. Since the second caption generation unit 203b is similar to the second caption generation unit 103b of the additional training device 10, the description thereof will be omitted.

The second feature extraction unit 203a extracts features of the images and features of the search queries from the training data. Then, the second feature extraction unit 203a outputs features (f⁻i₁, f⁻i₂, and so on) of the images to the second caption generation unit 203b, and outputs the features (f⁻i₁, f⁻i₂, and so on) of the images and features (f⁻t₁, f⁻t₂, and so on) of the search queries to the second similarity calculation unit 203c. Note that f⁻i₁ represents a feature extracted from the first image, and f⁻i₂ represents a feature extracted from the second image. Furthermore, f⁻t₁ represents a feature extracted from the search query associated to the first image, and f⁻t₂ represents a feature extracted from the search query associated to the second image. The second feature extraction unit 203a can extract the features of the images using, for example, a CNN-based model such as VGG or ResNet or a Vision Transformer (ViT) -based model. Furthermore, the second feature extraction unit 203a can extract the features of the search queries using a transformer-based model such as BERT.

The second similarity calculation unit 203c maps the feature of each of the images and the feature of each of the search queries in the same feature space and calculates the similarity of each pair of the image and the search query using the cosine similarity and the Euclidean distance. Then, the second similarity calculation unit 203c generates a similarity matrix (S⁻ _{i,j}) showing values of the similarity in the form of a matrix and outputs the similarity matrix to the old-new similarity loss calculation unit 206 and the retrieval loss calculation unit 207. Note that S⁻_{i,j} represents the similarity between the i-th image and the j-th search query.

The old-new similarity loss calculation unit 206 calculates a degree of discrepancy (hereinafter, also referred to as an “old-new similarity loss”) between the similarity matrix (S_{i,j}) stored in the similarity DB 15b and the similarity matrix (S⁻ _{i,j}) input from the in-training model 203 using the Kullback-Leibler (KL) information amount or the mean squared error (MSE). The old-new similarity loss calculation unit 206 outputs the old-new similarity loss to the update unit 205.

The retrieval loss calculation unit 207 receives the input of the similarity matrix (S⁻_{i,j}) from the second similarity calculation unit 203c. The retrieval loss calculation unit 207 calculates a loss (hereinafter, also referred to as a “retrieval loss”) from the similarity matrix (S⁻ _{i,j}) using a loss function such as InfoNCE (Noise Contrastive Estimation). The retrieval loss calculation unit 207 outputs the retrieval loss to the update unit 205. Note that the retrieval loss calculation unit 207 may calculate the retrieval loss from the similarity matrix (S⁻ _{i,j}) using a loss function such as cross-entropy.

The update unit 205 updates a parameter of the in-training model 203 based on the caption loss input from the caption loss calculation unit 204, the old-new similarity loss input from the old-new similarity loss calculation unit 206, and the retrieval loss input from the retrieval loss calculation unit 207. For example, the update unit 205 obtains a weighted average (hereinafter, also referred to as a “total loss”) of the caption loss, the old-new similarity loss, and the retrieval loss, and updates the parameter of the model in such a way as to minimize the total loss using an optimization algorithm such as SGD or Adam.

Then, the update unit 205 ends the processing when the total loss converges to a predetermined range, and regards the in-training model 203 at this time as an additionally trained model.

In the above configuration, the to-be-trained model 201 is an example of a learning model before being updated, the integration unit 202 is an example of a label generation means, the in-training model 203 is an example of a learning model being updated, and the caption loss calculation unit 204, the update unit 205, the old-new similarity loss calculation unit 206, and the retrieval loss calculation unit 207 are examples of a training means.

### Additional Training Processing

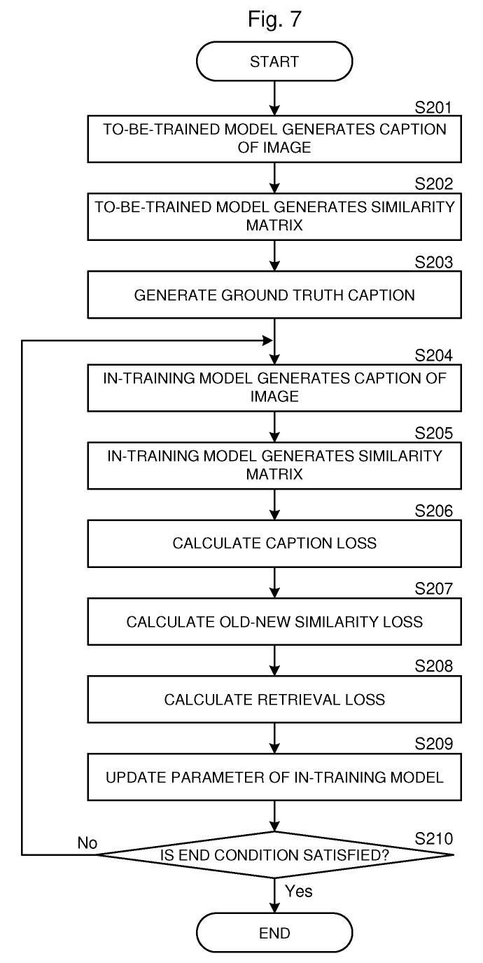

Next, processing of performing the additional training as described above will be described. FIG. 7 is a flowchart of additional training processing by the additional training device 20. This processing is achieved by the processor 12 illustrated in FIG. 2 executing a program prepared in advance and operating as each element illustrated in FIG. 6.

First, training data is input to the to-be-trained model 201. The to-be-trained model 201 generates a caption from an image of the training data (step S201). Then, the generated caption is output to the caption DB 15a. Furthermore, the to-be-trained model 201 calculates the similarity between the image and a search query and generates a similarity matrix (step S202). The to-be-trained model 201 outputs the similarity matrix to the similarity DB 15b.

Next, the search query of training data is input to the integration unit 202. Furthermore, the caption generated by the to-be-trained model 201 is input from the caption DB 15a to the integration unit 202. The integration unit 202 integrates the search query of the training data and the caption generated by the to-be-trained model 201 to generate a ground truth caption (step S203).

Next, the training data is input to the in-training model 203. The in-training model 203 generates a caption of the image from the image of the training data (step S204). The in-training model 203 outputs the generated caption to the caption loss calculation unit 204. Furthermore, the in-training model 203 calculates the similarity between the image and the search query and generates a similarity matrix (step S205). The in-training model 203 outputs the similarity matrix to the old-new similarity loss calculation unit 206 and the retrieval loss calculation unit 207.

Next, the caption loss calculation unit 204 calculates a caption loss based on the ground truth caption and the caption generated by the in-training model 203 (step S206). The caption loss calculation unit 204 outputs the caption loss to the update unit 205.

Next, the old-new similarity loss calculation unit 206 calculates an old-new similarity loss based on the similarity matrix generated by the to-be-trained model 201 and the similarity matrix generated by the in-training model 203 (step S207). Specifically, the old-new similarity loss calculation unit 206 calculates a degree of discrepancy between the similarity matrix generated by the to-be-trained model 201 and the similarity matrix generated by the in-training model 203, using the Kullback-Leibler (KL) information amount or the mean squared error. The old-new similarity loss calculation unit 206 outputs the old-new similarity loss to the update unit 205.

Next, the retrieval loss calculation unit 207 calculates a retrieval loss based on the similarity matrix generated by the in-training model 203 (step S208). Specifically, the retrieval loss calculation unit 207 calculates the loss from the similarity matrix generated by the in-training model 203 using a loss function such as InfoNCE. The retrieval loss calculation unit 207 outputs the retrieval loss to the update unit 205.

Next, the update unit 205 updates a parameter of the in-training model 203 based on the caption loss, the old-new similarity loss, and the retrieval loss (step S209). The processing in steps S204 to S209 is repeatedly executed until a predetermined end condition is satisfied, and the processing ends in a case where the predetermined end condition is satisfied (step S210: Yes).

The additional training device 20 according to the second example embodiment can perform additional training that improves retrieval accuracy for a learning target while preventing forgetting of learned knowledge, which is similar to the additional training device 10 according to the first example embodiment.

### Modified Example

Next, a modified example of the second example embodiment will be described.

As in the modified example of the first example embodiment, an additional training device according to the modified example of the second example embodiment may also include a division unit that divides a ground truth caption into a portion to be input to the in-training model 203 and a portion to be treated as a ground truth caption, and may perform additional training of a VLM that can generate a caption using an image and a text.

### Third Example Embodiment

Next, a third example embodiment will be described. In the third example embodiment, a ground truth caption is input to an in-training model. Then, an old-new similarity loss and a retrieval loss are calculated using the similarity between an image and the ground truth caption output by the in-training model to update a parameter of the model. Since an overall configuration and a hardware configuration of an additional training device 30 according to the third example embodiment are similar to those of the additional training device 10 according to the first example embodiment, the description thereof will be omitted. The additional training device 30 is an example of a training device.

### Functional Configuration

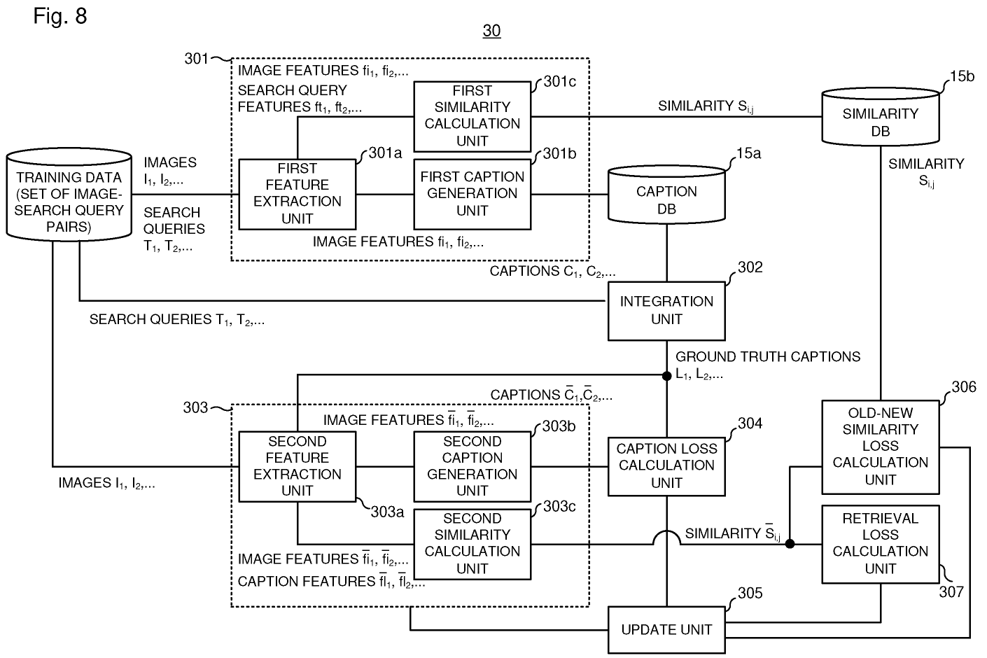

FIG. 8 is a block diagram illustrating a functional configuration of the additional training device 30. The additional training device 30 functionally includes a to-be-trained model 301, an integration unit 302, an in-training model 303, a caption loss calculation unit 304, an update unit 305, an old-new similarity loss calculation unit 306, a retrieval loss calculation unit 307, the caption DB 15a, and the similarity DB 15b.

The caption DB 15a and the similarity DB 15b are achieved by the DB 15 illustrated in FIG. 2. The to-be-trained model 301, the integration unit 302, the in-training model 303, the caption loss calculation unit 304, the update unit 305, the old-new similarity loss calculation unit 306, and the retrieval loss calculation unit 307 are configured by the processor 12 illustrated in FIG. 2.

Since the to-be-trained model 301, the integration unit 302, and the caption loss calculation unit 304 are similar to the to-be-trained model 201, the integration unit 202, and the caption loss calculation unit 204 of the additional training device 20 according to the second example embodiment, the description thereof will be omitted.

Images (I₁, I₂, and so on) of training data are input to the in-training model 303. Furthermore, ground truth captions (L₁, L₂, and so on) are input from the integration unit 302 to the in-training model 303. The in-training model 303 generates captions from the images of the training data and outputs the generated captions to the caption loss calculation unit 304. Furthermore, the in-training model 303 calculates the similarity between each of the images and each of the ground truth captions and outputs the similarity to the old-new similarity loss calculation unit 306 and the retrieval loss calculation unit 307.

Specifically, the in-training model 303 includes a second feature extraction unit 303a, a second caption generation unit 303b, and a second similarity calculation unit 303c. Since the second caption generation unit 303b is similar to the second caption generation unit 203b of the additional training device 20, the description thereof will be omitted.

The second feature extraction unit 303a extracts features (f⁻i₁, f⁻i₂, and so on) of the images from the images (I₁, I₂, and so on) of the training data, and extracts features (f⁻l₁, f⁻l₂, and so on) of the ground truth captions from the ground truth captions (L₁, L₂, and so on). Note that f⁻l₁ represents a feature extracted from a ground truth caption associated to the first image, and f⁻l₂ represents a feature extracted from a ground truth caption associated to the second image. The second feature extraction unit 303a can extract the features of the images using, for example, a CNN-based model such as VGG or ResNet or a Vision Transformer (ViT) -based model. Furthermore, the second feature extraction unit 303a can extract the features of the ground truth captions using a transformer-based model such as BERT.

The second similarity calculation unit 303c maps the feature of each of the images and the feature of each of the ground truth captions in the same feature space and calculates the similarity of each pair of the image and the ground truth caption using the cosine similarity and the Euclidean distance. Then, the second similarity calculation unit 303c generates a similarity matrix (S⁻ _{i,j}) showing values of the similarity in the form of a matrix and outputs the similarity matrix to the old-new similarity loss calculation unit 306 and the retrieval loss calculation unit 307. Note that S⁻_{i,j} represents the similarity between the i-th image and the j-th ground truth caption.

The old-new similarity loss calculation unit 306 calculates a degree of discrepancy (that is, an old-new similarity loss) between the similarity matrix (S_{i,j}) stored in the similarity DB 15b and the similarity matrix (S⁻_{i,j}) input from the in-training model 303 using the Kullback-Leibler (KL) information amount or the mean squared error. The old-new similarity loss calculation unit 306 outputs the old-new similarity loss to the update unit 305. The retrieval loss calculation unit 307 calculates a retrieval loss from the similarity matrix (S⁻_{i,j}) input from the in-training model 303 using a loss function such as InfoNCE. The retrieval loss calculation unit 307 outputs the retrieval loss to the update unit 305.

The update unit 305 updates a parameter of the in-training model 303 based on the caption loss input from the caption loss calculation unit 304, the old-new similarity loss input from the old-new similarity loss calculation unit 306, and the retrieval loss input from the retrieval loss calculation unit 307. For example, the update unit 305 obtains a weighted average of the caption loss, the old-new similarity loss, and the retrieval loss, and updates the parameter of the model in such a way as to minimize a total loss using an optimization algorithm such as SGD or Adam.

In the above configuration, the to-be-trained model 301 is an example of a learning model before being updated, the integration unit 302 is an example of a label generation means, the in-training model 303 is an example of a learning model being updated, and the caption loss calculation unit 304, the update unit 305, the old-new similarity loss calculation unit 306, and the retrieval loss calculation unit 307 are examples of a training means.

### Additional Training Processing

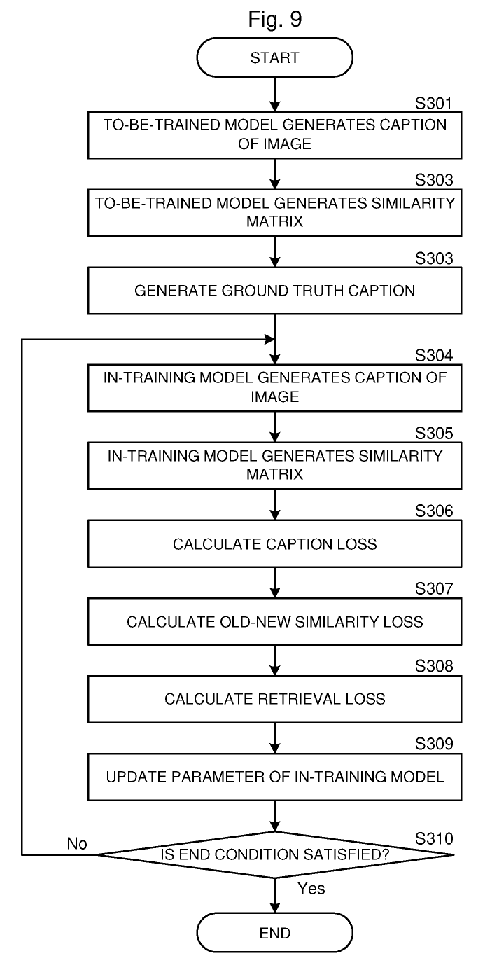

Next, processing of performing the additional training as described above will be described. FIG. 9 is a flowchart of additional training processing by the additional training device 30. This processing is achieved by the processor 12 illustrated in FIG. 2 executing a program prepared in advance and operating as each element illustrated in FIG. 8.

Since steps S301 to S304 and step S306 are similar to steps S201 to S204 and step S206 of the additional training processing of the second example embodiment, the description thereof will be omitted.

An image of training data is input to the in-training model 303. Furthermore, a ground truth caption is input from the integration unit 302 to the in-training model 303. The in-training model 303 calculates the similarity between the image and the ground truth caption and generates a similarity matrix (step S305). Then, the in-training model 303 outputs the similarity matrix to the old-new similarity loss calculation unit 306 and the retrieval loss calculation unit 307.

Next, the old-new similarity loss calculation unit 306 calculates an old-new similarity loss based on the similarity matrix generated by the to-be-trained model 301 and the similarity matrix generated by the in-training model 303 (step S307). Specifically, the old-new similarity loss calculation unit 306 calculates a degree of discrepancy between the similarity matrix generated by the to-be-trained model 301 and the similarity matrix generated by the in-training model 303, using the Kullback-Leibler (KL) information amount or the mean squared error. The old-new similarity loss calculation unit 306 outputs the old-new similarity loss to the update unit 305.

Next, the retrieval loss calculation unit 307 calculates a retrieval loss based on the similarity matrix generated by the in-training model 303 (step S308). Specifically, the retrieval loss calculation unit 307 calculates the retrieval loss from the similarity matrix input from the in-training model 303 using a loss function such as InfoNCE. The retrieval loss calculation unit 307 outputs the retrieval loss to the update unit 305.

Next, the update unit 305 updates a parameter of the in-training model 303 based on the caption loss, the old-new similarity loss, and the retrieval loss (step S309). The processing in steps S304 to S309 is repeatedly executed until a predetermined end condition is satisfied, and the processing ends in a case where the predetermined end condition is satisfied (step S310: Yes).

The additional training device 30 according to the third example embodiment can perform additional training that improves retrieval accuracy for a learning target while preventing forgetting of learned knowledge, which is similar to the additional training device 10 according to the first example embodiment.

### Application Example

Next, an application example of the additional training devices of the first example embodiment, the second example embodiment, and the third example embodiment will be described.

### Application Example: Image Retrieval

The additional training device of the present disclosure can be used for image retrieval to grasp a disaster situation at the time of disaster. For example, in a case where an image indicating the disaster situation cannot be retrieved by a model before training, the model before training is additionally trained using the additional training device of the present disclosure in such a way that the image indicating the disaster situation can be retrieved. At this time, a pair of an image of a site of disaster and a search query (for example, “collapsed building” or “cut road”) is used as training data. By additionally training the model with the training data as described above, it is possible to retrieve an image of an area where disaster strikes while preventing forgetting.

Furthermore, the additional training device of the present disclosure can also be used in a case where more detailed image retrieval is desired. For example, the additional training device of the present disclosure can perform additional training on a model before training, which performs rough image retrieval related to a person (for example, “a seated person”) in such a way that detailed image retrieval related to a person (for example, “a seated person carrying a red bag”) can be performed. In the above case, a pair of an image of a person and a search query “red bag” is used as training data.

### Fourth Example Embodiment

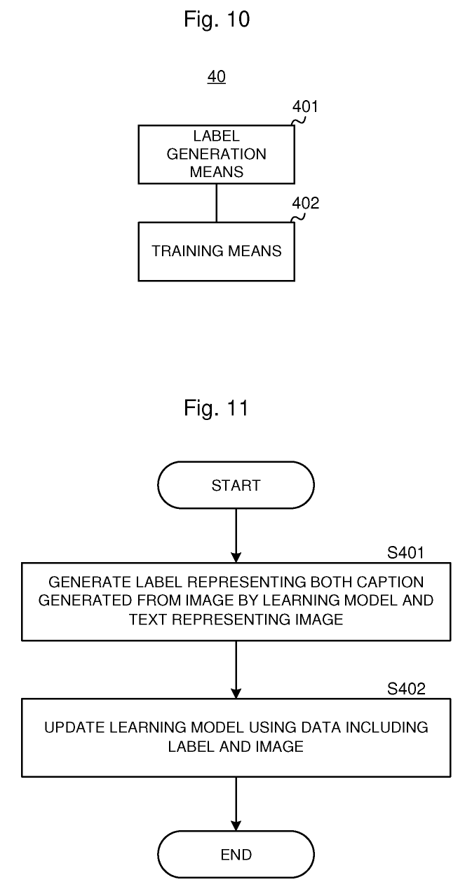

FIG. 10 is a block diagram illustrating a functional configuration of a training device according to a fourth example embodiment. A training device 40 includes a label generation means 401 and a training means 402.

FIG. 11 is a flowchart of processing by the training device of the fourth example embodiment. The label generation means 401 generates a label representing both a caption generated from an image by a learning model and text representing the image (step S401). The training means 402 updates the learning model using data including the label and the image (step S402).

The label generation means 401 can be achieved by using the integration unit 102 according to the first example embodiment. The training means 402 can be achieved by using the caption loss calculation unit 104 and the update unit 105 according to the first example embodiment.

According to the training device of the fourth example embodiment, it is possible to improve retrieval accuracy for a learning target while preventing forgetting of learned knowledge.

Some or all of the above example embodiments may be described as the following Supplementary Notes, but are not limited to the following.

(Supplementary Note 1)
A training device including:
   a label generation means for generating a label representing both a caption generated from an image by a learning model and text representing the image;
   a training means for updating the learning model using data including the label and the image.

(Supplementary Note 2)
The training device according to Supplementary Note 1, wherein the learning model is a vision and language model.

(Supplementary Note 3)
The training device according to Supplementary Note 1, wherein the training means calculates a caption loss based on a caption generated from the image by the learning model being updated and the label and updates a parameter of the learning model.

(Supplementary Note 4)
The training device according to Supplementary Note 3, wherein
the learning model before being updated calculates old similarity based on a pair of the image and the text representing the image,
the learning model being updated calculates new similarity based on a pair of the image and the text representing the image, and
the training means calculates an old-new similarity loss based on the old similarity and the new similarity, calculates a retrieval loss based on the new similarity, and updates the parameter of the learning model.

(Supplementary Note 5)
The training device according to Supplementary Note 3 or 4, further including a division means for dividing the label into first information to be input to the learning model being updated and second information to be treated as a ground truth,
wherein the training means calculates a caption loss based on a caption generated from the image and the first information by the learning model being updated, and the second information, and updates the parameter of the learning model.

(Supplementary Note 6)
The training device according to Supplementary Note 3, wherein
the learning model before being updated calculates old similarity based on a pair of the image and the text representing the image,
the learning model being updated calculates new similarity based on the image and the label representing the image, and
the training means calculates an old-new similarity loss based on the old similarity and the new similarity, calculates a retrieval loss based on the new similarity, and updates the parameter of the learning model.

(Supplementary Note 7)
The training device according to Supplementary Note 1, wherein the label generation means integrates the caption generated by the learning model and the text representing the image using a delimiter.

(Supplementary Note 8)
The training device according to Supplementary Note 7, wherein the label generation means integrates the caption generated by the learning model and the text representing the image and inputs the integrated text to natural language processing to calibrate the integrated text.

(Supplementary Note 9)
A training method executed by a computer, the training method including: generating a label representing both a caption generated from an image by a learning model and text representing the image; and updating the learning model using data including the label and the image.

(Supplementary Note 10)
A program for causing a computer to execute processing of:
   generating a label representing both a caption generated from an image by a learning model and text representing the image; and
   updating the learning model using data including the label and the image.

(Supplementary Note 11)
The training device according to Supplementary Note 2, wherein the text representing the image is new text that enables retrieval of the image.

While the present disclosure has been described with reference to the example embodiments and examples thereof, the present disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

10, 20, 30 additional training device
15 database (DB)
15a caption DB
15b similarity DB
101, 201, 301 to-be-trained model
102, 202, 302 integration unit
103, 203, 303 in-training model
104, 204, 304 caption loss calculation unit
105, 205, 305 update unit
206, 306 old-new similarity loss calculation unit
207, 307 retrieval loss calculation unit

1. A training device comprising:
at least one memory configured to store instructions; and
at least one processor configured to execute the instructions to:
generate a label representing both a caption generated from an image by a learning model and text representing the image; and
update the learning model using data including the label and the image.

2. The training device according to claim 1, wherein the learning model is a vision and language model.

3. The training device according to claim 1, wherein the one or more processors calculate a caption loss based on a caption generated from the image by the learning model being updated and the label, and update a parameter of the learning model.

4. The training device according to claim 3, wherein
the learning model before being updated calculates old similarity based on a pair of the image and the text representing the image,
the learning model being updated calculates new similarity based on a pair of the image and the text representing the image, and
the one or more processors calculate an old-new similarity loss based on the old similarity and the new similarity, calculate a retrieval loss based on the new similarity, and update the parameter of the learning model.

5. The training device according to claim 3, the one or more processors are further configured to divide the label into first information to be input to the learning model being updated and second information to be treated as a ground truth,
wherein the one or more processors calculate a caption loss based on a caption generated from the image and the first information by the learning model being updated, and the second information, and update the parameter of the learning model.

6. The training device according to claim 3, wherein
the learning model before being updated calculates old similarity based on a pair of the image and the text representing the image,
the learning model being updated calculates new similarity based on the image and the label representing the image, and
the one or more processors calculate an old-new similarity loss based on the old similarity and the new similarity, calculate a retrieval loss based on the new similarity, and update the parameter of the learning model.

7. The training device according to claim 1, wherein the one or more processors integrate the caption generated by the learning model and the text representing the image using a delimiter.

8. The training device according to claim 7, wherein the one or more processors integrate the caption generated by the learning model and the text representing the image and input the integrated text to natural language processing to calibrate the integrated text.

9. The training device according to claim 2, wherein the text representing the image is new text that enables retrieval of the image.

10. A training method comprising:
generating a label representing both a caption generated from an image by a learning model and text representing the image; and
updating the learning model using data including the label and the image.

11. A non-transitory computer readable recording medium recording a program for causing a computer to execute processing comprising:
generating a label representing both a caption generated from an image by a learning model and text representing the image; and
updating the learning model using data including the label and the image.
